(19) United States
(12) Patent Application Publication
(10) Pub. No.: US 2003/0233947 A1
(43) Pub. Date: Dec. 25, 2003

(54) Luminous delicacy

(76) Inventor: Roland Serge Henri Caville, Kowloon (HK)

Correspondence Address: YOUNG & THOMPSON, 745 SOUTH 23RD STREET 2ND FLOOR, ARLINGTON, VA, 22202

(21) Appl. No.: 10/355,022

(22) Filed: Jan. 31, 2003

(30) Foreign Application Priority Data
Jun. 24, 2002 (FR) 02.07773
Jan. 22, 2003 (FR) 03.00643

(51) Int. Cl. A23L 1/00

(52) U.S. Cl. 99/494

(57) ABSTRACT

A device for a luminous delicacy, such as a lollipop, of the type comprising a housing, serving as a handle in which are disposed the electrical means supplying a light source adapted to illuminate the lollipop, comprises two hollow tubes of which one, connected to the housing comprising the electrical energy source, is provided at its distal end with a light source and of which the other penetrates the interior of the delicacy.

The present invention relates to a delicacy such as a sorbet, a bonbon, a lollipop or the like whose material is translucent and within which is introduced a support provided at one end with a light source, and comprising means to receive a source of electrical energy.

In U.S. Pat. No. 4,914,748, there is disclosed a device permitting illuminating a delicacy constituted by a housing, comprising electrical means supplying a miniature ampoule disposed in the end of the housing, the delicacy itself being fixed to the end of the housing.

There are described analogous arrangements in Spanish utility model ES 1 031 880, German utility model G 94 12 165, U.S. Pat. Nos. 5,860,732, 6,054,156, 6,325,693 and 6,221,407.

The advantage of all these devices is that the electrical means being outside the delicacy, the mouth or the tongue of the consumer can never come into contact with them, which leads to complete safety of use.

But the drawback of these devices is that the delicacy is illuminated from the outside and not from the inside; thus the effect produced is mediocre.

In U.S. Pat. No. 6,416,800, there is described a delicacy which is illuminated throughout its mass because it comprises edible optical fibers.

It happens however that the optical fibers do not emit sufficient light, so that it must be a dark piece, or else in the night, for the effect of illumination of the delicacy to be visible.

In U.S. Pat. No. 6,135,606, there is described a means by which a light source is disposed within the delicacy; but according to this patent, the delicacy must be attached to the stick carrying the light source, which is not practical and the light source being embedded in the resin, the transmission of the light is defective.

The present invention has for its object to overcome all these drawbacks and this by very simple and hence very economical means, which is indispensable for lollipops.

The present invention relates to a device for a luminous delicacy such as a lollipop, which can easily be held in the hand by a child, of the type comprising a housing, serving as a handle, in which are disposed the electrical means supplying a light source, adapted to illuminate the lollipop, said device comprising:

a base or a housing which can serve as a handle, containing on the one hand an electrical energy source and on the other hand connection means;

a first hollow tube, disposed in prolongation of said housing, provided at its distal end with a light source, connected by conductors, disposed in said tube, to said electrical source;

a second hollow tube, open at its lower end, which is threaded over the first hollow tube;

a delicacy, within which the distal end of the second hollow tube penetrates;

said delicacy and said second hollow tube constituting a removable assembly, which can be threaded over the first hollow tube or else can be withdrawn.

such that when said removable assembly is threaded on the first hollow tube, it will be possible to illuminate the delicacy from its interior and, when the delicacy is consumed, the second hollow tube can be withdrawn and a new assembly can be put into place; the consumption of the delicacy taking place without the mouth or the tongue of the consumer coming into contact with an electrical element.

The present invention can also comprise the following characteristics:

the light source is a miniature ampoule;

the light source is a luminous electro-diode (LED);

the connection means are of the pusher type;

the connection means are connected by movement of the first tube relative to the housing;

the electrical energy source is a conventional battery;

the energy source is a flat battery of the “button battery” type;

the second hollow tube is transparent, at least in its portion penetrating the delicacy;

the second hollow tube is closed at its upper end.

By way of non-limiting examples, there is shown on the accompanying drawings:

FIG. 1, an elevational and longitudinal cross-sectional view of an embodiment of the invention.

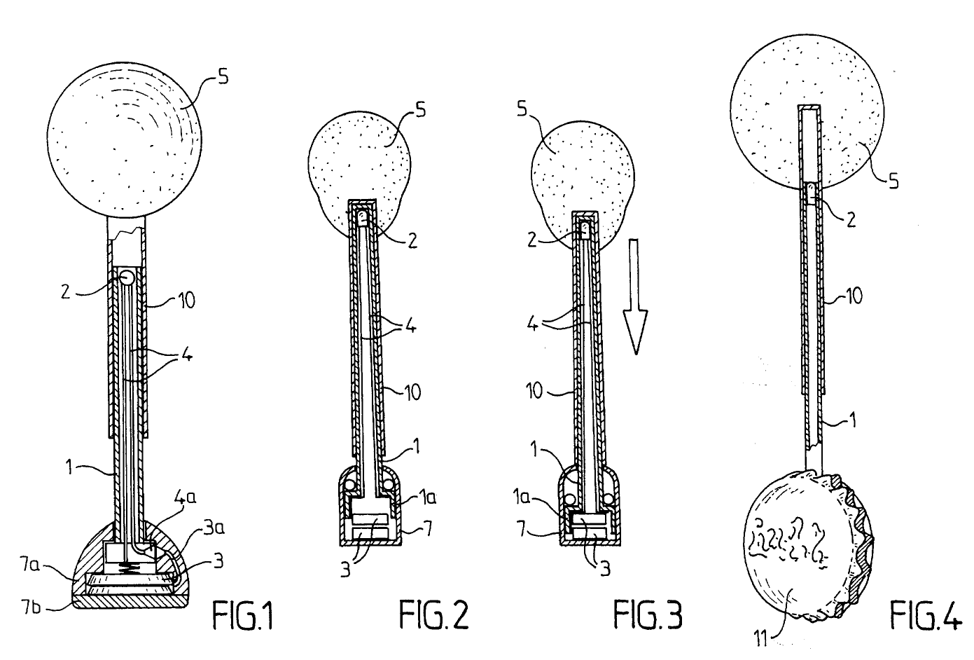

FIGS. 2 and 3, two views of a modified embodiment of the device of FIG. 1.

FIG. 4, a perspective view of a modified embodiment of the device of FIG. 1.

FIG. 5, a fragmentary cross-sectional view of FIG. 4.

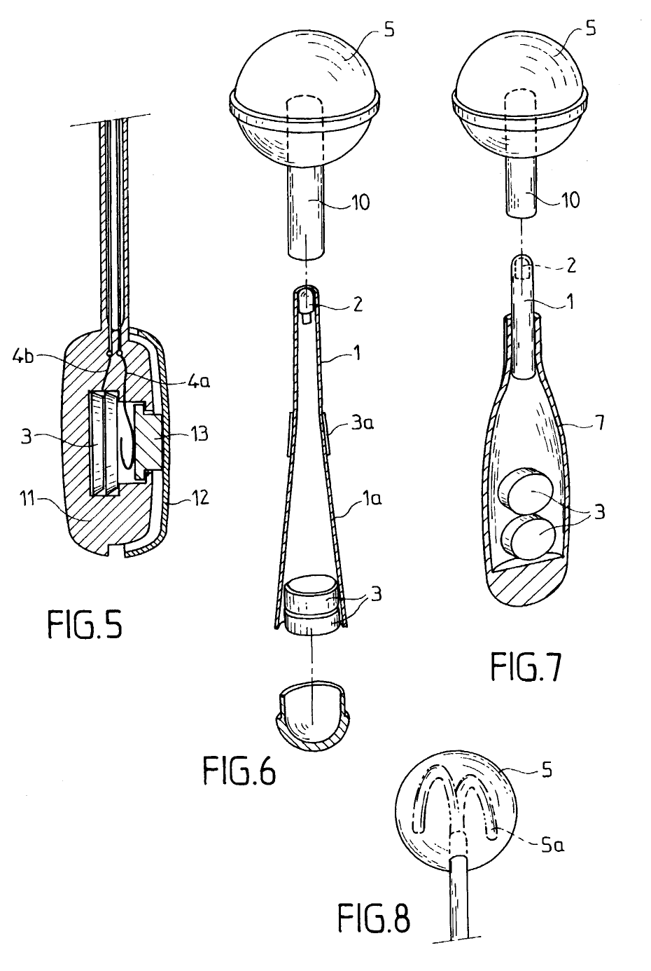

FIGS. 6 and 7, two perspective views of two other embodiments of the invention.

FIG. 8, a fragmentary view illustrating a modified embodiment of the delicacy.

Referring to FIG. 1, it is seen that the device is constituted by a housing 7 within which is disposed a luminous energy source, or battery 3.

On this housing 7 is disposed a first hollow tube 1, at the distal end of which is placed a light source 2.

Said light source is supplied by two electrical conductors 4, disposed within said hollow tube 1.

Preferably, a switch or another electrical connection means 3a is disposed on one of the conductors 4.

The delicacy 5 is secured to a second transparent hollow tube 10, which penetrates the mass of the delicacy 5 and which has an internal diameter slightly greater than the external diameter of the stick 1, so as to be able to be threaded over said stick 1. When the hollow tube 10 is entirely threaded over the stick 1, the luminescent diode 2 is located within the delicacy 5 and hence can illuminate it from the interior when the diode 2 is powered.

Preferably, the second hollow tube is closed at its upper end located within the mass of the delicacy.

The delicacy 5 can be a bonbon, a lollipop, a sorbet or any other type of delicacy: it is important only that it be translucent, so that the light, emitted by the diode or the lamp, will diffuse within the mass of said delicacy to illuminate it.

FIGS. 2 and 3 show a modified embodiment of FIG. 1 as to the connection means.

In this modification, the hollow tube 1, which carries at its upper end the diode 2, is movable relative to the housing 7 (it can serve as a base) in which are disposed the batteries 3.

The lower end of the housing 7 is cylindrical and the lower end la of the tube 1 is also cylindrical and can slide within the housing 7.

When the tube 1 is in the upper position (FIG. 2), the electrical circuit is open; when the tube 1 is in the lower position, the ends of the conductors 4, disposed within the portion la of the tube, effect the electrical connection.

According to the embodiment of FIGS. 4 and 5, the battery 3 is disposed in a circular housing 11, provided with a flexible cover 12. One of the electrical wires 4a is placed in contact with the battery 3 by a push-button; the other wire 4b being connected to the battery 3.

This arrangement permits giving the housing 11 and its cover 12 the desired external appearance, for example that of a Coca-Cola bottle cap.

FIGS. 6 and 7 show two other embodiments of the invention, the same elements having the same reference numerals.

In FIG. 6, it is seen that the hollow tube 1 is prolonged at its base by an elongated conical base la, also hollow, which serves to house the batteries 3. The tube 1 and its prolongation la form a sort of sleeve in which is disposed a switch 3a.

As in the case of FIG. 1, the delicacy 5 is provided with a hollow tube 10 which is threaded on the tube 1; such that the diode 2 will be within the delicacy 5.

In FIG. 7, it will be seen that the hollow tube 1, which carries the luminescent diode 2, can be relatively short and carried by a hollow sleeve which constitutes the housing 7 in which are disposed the batteries 3.

As in the case of FIGS. 1 to 7, the delicacy 5 is provided with a hollow tube 10 which will be threaded over the stick 1, such that the diode 2 will be within the delicacy 5.

In all the examples shown in FIGS. 1 to 7, if the second hollow tube 10 is closed at its end, this will have the advantage that when the delicacy 5 will have been entirely absorbed, the luminous lamp 2 will always be maintained out of contact with the tongue or the mouth of the consumer.

FIG. 8 shows a modified embodiment of the delicacy 5.

This figure shows that you can have, in the mass of the delicacy 5, a decorative element 5a which is of a different color or consistency than that of the delicacy itself, which appears when the diode 2 is illuminated. In the illustrated example, the decorative element is constituted by the stylized logo of the McDonald company whose central branch faces the light source such that the logo constitutes a light guide.

1. Device for a luminous delicacy, such as a lollipop, of the type comprising a housing, serving as a handle in which are disposed the electrical means supplying a light source adapted to illuminate the lollipop, characterized in that the device comprises two hollow tubes of which one, connected to the housing comprising the electric energy source, is provided at its distal end with a light source and of which the other penetrates the interior of the delicacy.

2. Device according to claim 1, characterized by the fact that it comprises:
a circle or housing (7, 11) that can serve as a handle, containing on the one hand an electric energy source (3) and on the other hand electrical connection means (3a, 13);
a first hollow tube (1) disposed in prolongation of said housing (7, 11), provided at its distal end with a light source (2), connected by conductors (4), disposed in the tube (1), to said electrical energy source (3);
a second hollow tube (10) , closed at its distal end and open at its other end, that is threaded over the first hollow tube (1);
a delicacy (5) within which the distal end of the second hollow tube penetrates;
said delicacy (5) and said second hollow tube (10) constituting a removable assembly (5-10), which can be threaded over the first hollow tube (1) or else be withdrawn;
such that when said removable assembly (5-10) is threaded over the first hollow tube (1) it will be possible to illuminate the delicacy (5) from its interior and that, when the delicacy (5) is consumed the hollow tube (10) can be withdrawn from the hollow tube (1) and there can be emplaced a new assembly (5-10), the consumption of the delicacy taking place without the tongue or mouth of the consumer coming into contact with an electrical element.

3. Device according to claim 2, in which the light source (2) is a miniature ampoule.

4. Device according to claim 2, in which the light source (2) is a luminous electro-diode (LED).

5. Device according to claim 2, in which the connection means (3) are of the pusher type (3, 13).

6. Device according to claim 2, in which the connection means are carried out by movement of the tube (1) relative to the housing (7).

7. Device according to any one of the preceding claims, in which the second hollow tube (10) is transparent, at least in its portion penetrating the interior of the delicacy (5).

8. Device according to any one of the preceding claims, in which the second hollow tube (10) is closed at its upper end located within the delicacy (5).

9. Device according to any one of the preceding claims, in which the delicacy (5) comprises within its mass a decorative design.
